(19) United States
(12) Patent Application Publication
(10) Pub. No.: US 2008/0280630 A1
(43) Pub. Date: Nov. 13, 2008

(54) SYSTEM AND METHOD FOR BROADCASTING PAGE MESSAGES IN POOR COVERAGE REGIONS

(76) Inventors: Amit KALHAN, La Jolla, CA (US); Henry Chang, San Diego, CA (US); Timothy Thome, Spring Valley, CA (US); Doug Dunn, Chula Vista, CA (US)

Correspondence Address: KYOCERA WIRELESS CORP., P.O. BOX 928289, SAN DIEGO, CA, 92192-8289, US

(21) Appl. No.: 11/746,532

(22) Filed: May 9, 2007

(51) Int. Cl. H04Q 7/38

(52) U.S. Cl. 455/458

(57) ABSTRACT

A system and method for paging wireless mobile devices selectively varies the effective modulation order of a paging channel to achieve improved coverage in a wireless wide area network (WWAN) cell. In one embodiment, the paging channel modulation order is selected based on a measured signal strength and/or common channel error rate. The selected modulation order is directly related to the quality of the channel environment. In another embodiment, a page message is segregated into base and extended components that are layer modulated. With layered modulation, wireless mobile devices in good coverage regions can successfully demodulate both the base and extended components to recover the entire page message. Wireless mobile devices in poor coverage regions can successfully demodulate the base component of the page message, and then request that the extended component of the page message be re-broadcast as a base component to thereby recover the entire page message.

### RELATED APPLICATION

This application is related to U.S. patent application No. ______, filed ______, entitled “System and Method for Broadcasting Overhead Parameters in Poor Coverage Regions”, having Attorney Docket No. TUTL 00136, and assigned to the assignee of the present application, the disclosure of which is fully incorporated herein by reference in entirety.

### TECHNICAL FIELD

The invention generally relates to wireless communications systems, and more particularly, to a novel and improved system and method for paging wireless mobile devices.

### BACKGROUND

In recent years there has been an explosion of various wireless technologies such as WiFi (802.11), 3G (CDMA), WiMax (802.16) and many others. All of these technologies use different modulation schemes and access methods, such as code division multiple access (CDMA), orthogonal frequency division multiple access (OFDMA), or the like. To access network services using these different technologies, multi-mode mobile devices have been developed. Multi-mode devices are end-user devices configured to selectively interface to different wireless technologies. They allow users to connect to wireless communications networks irrespective of the underlying access technology.

Users of multi-mode wireless devices are mostly interested in network support for their particular applications, regardless of the underlying access technology. More importantly, users are interested in receiving uninterrupted services regardless of the access technology. Uninterrupted service is possible through a system design concept called seamless mobility. Seamless mobility provides the user with seamless access and connectivity across different wireless technologies and different wireless networks, such as wireless local area networks (WLANs), e.g., WiFi networks, and wireless wide area networks (WWANs), such as cellular phone networks.

Although WWAN air interface technologies such as GSM, cdma2000 and the like are designed to cover the regions surrounding their base stations (cells), not all areas within the intended coverage regions can receive WWAN service. These areas that lack coverage are typically known as coverage holes. WWAN coverage holes frequently occur inside buildings. To obtain wireless services within buildings or other coverage holes, multi-mode devices often connect to a WLAN providing coverage within the building or WWAN coverage hole. However, even though WLAN services may be available in some indoor environments, it is often desirable to continue receiving certain WWAN services within these coverage holes, sometimes because the WWAN service is simply not available from the WLAN or the equivalent WLAN service does not provide the features or level of quality desired by the multi-mode device user. WWAN paging is one such service. To improve user perception of seamless mobility, wireless mobile devices operating indoors or in other types of WWAN coverage holes should be able to receive WWAN pages. A possible solution is to improve WWAN technology so that WWAN pages are directly broadcasted over the WWAN, even to those users in coverage holes experiencing poor or no apparent WWAN coverage.

### SUMMARY

It is an advantage of the present invention to provide a system and method for successfully broadcasting pages over a WWAN into coverage holes, such as buildings, where WWAN services are not typically available. Wireless mobile devices actively operating on a WLAN are capable of receiving pages over WWAN. The ability to receive WWAN pages in areas where they are conventionally unavailable greatly enhances the value of WWAN paging service and can facilitate an improved user perception of the concept of seamless mobility.

Other advantages of the invention will be or will become apparent to one with skill in the art upon examination of the following figures and detailed description. It is intended that all such additional advantages be included within this description, be within the scope of the invention, and be protected by the accompanying claims.

### BRIEF DESCRIPTION OF THE DRAWINGS

It is to be understood that the drawings are solely for purpose of illustration and do not define the limits of the invention. Furthermore, the components in the figures are not necessarily to scale, emphasis instead being placed upon illustrating the principles of the invention. In the figures, like reference numerals designate corresponding parts throughout the different views.

FIG. 1 is a conceptual diagram of a wireless communications system in accordance with an exemplary embodiment of the present invention.

FIG. 2 is a block diagram illustrating details of the access node and one of the wireless mobile devices included in the communications system of FIG. 1

FIG. 3 is a flowchart illustrating a first method of broadcasting a page message in the communications system of FIG. 1.

FIG. 4 is a flowchart illustrating a second method of broadcasting a page message in the communications system of FIG. 1.

FIGS. 5-6 are flowcharts illustrating a third method of broadcasting a page message in the communications system of FIG. 1.

FIG. 7 is a diagram illustrating access node components for broadcasting page messages using layered modulation.

FIG. 8 is a conceptual diagram illustrating the multiplexing of the base and extended logical channels.

FIG. 9 shows an exemplary QAM constellation used by the layered modulator shown in FIG. 7.

FIG. 10 is a flowchart illustrating a method of processing a layer-modulated page message at a wireless mobile device.

FIG. 11 is a diagram illustrating wireless mobile device components for recovering layer-modulated page messages.

### DETAILED DESCRIPTION

The following detailed description, which references to and incorporates the drawings, describes and illustrates one or more specific embodiments of the invention. These embodiments, offered not to limit but only to exemplify and teach the invention, are shown and described in sufficient detail to enable those skilled in the art to practice the invention. Thus, where appropriate to avoid obscuring the invention, the description may omit certain information known to those of skill in the art.

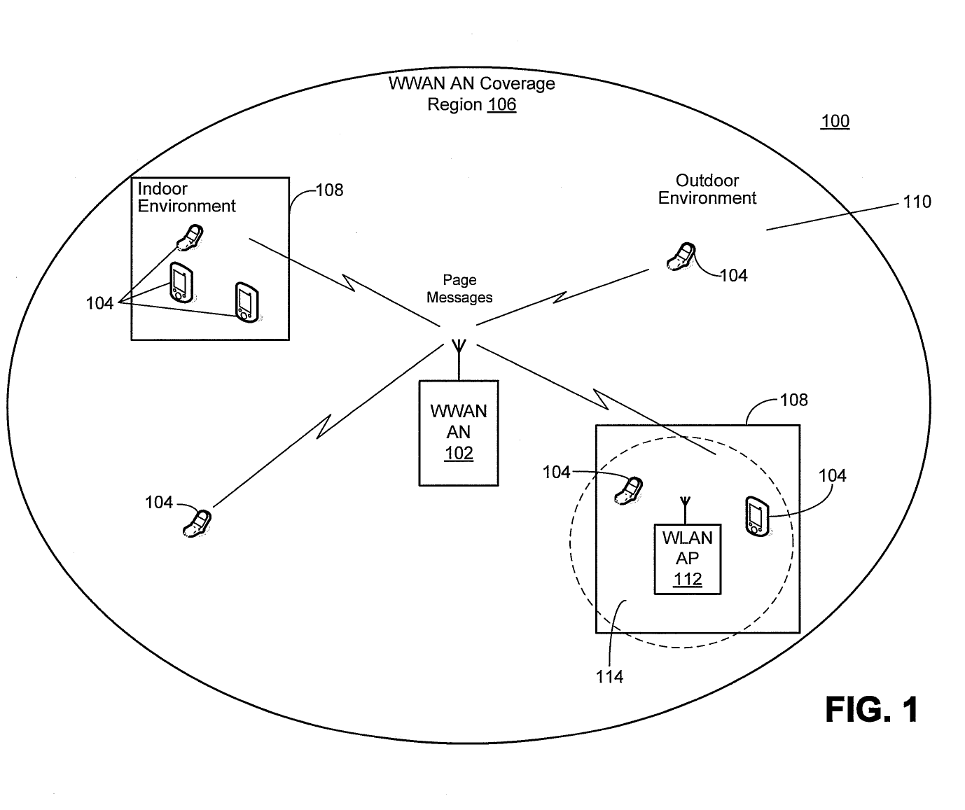

FIG. 1 is a conceptual diagram of wireless communications system 100 in accordance with an exemplary embodiment of the present invention. The wireless communications system 100 includes a wireless wide area network (WWAN) having a plurality of cells and one or more wireless local area networks (WLANs) within the coverage area of the WWAN.

For simplicity, FIG. 1 shows only a single WWAN cell (WWAN coverage region 106) provided by a WWAN access node (AN) 102. In the example shown, the WWAN coverage region 106 overlays a single WLAN coverage area 114, which is provided by a WLAN access point (AP) 112. Additional WLAN coverage areas and APs could be present in the WWAN coverage region 106, but are omitted from FIG. 1 for simplicity.

One or more wireless mobile devices 104 (e.g., cellular phones, personal digital assistants (PDAs) or the like) are included in the communications system 100 and are capable of radio communications with the WWAN through AN 102. The wireless mobile devices 104 can include multi-mode wireless devices capable of radio communications with both the WWAN AN 102 and the WLAN AP 112. The wireless mobile devices 104 actively operating on the WLAN are capable of monitoring and receiving WWAN page messages, as is described in further detail below.

The exemplary WWAN coverage region 106 contains three different types of radio channel environments: an indoor environment 108, an outdoor environment 110 and an outdoor-to-indoor environment. The indoor environment 108 is characterized by being located within a structure, such as a building. A structure may have permanent or temporary structures or elements, such as walls, within it. There may also be other objects as well. For example, a warehouse with no interior walls may be empty or it might be filled with cargo containers stacked to the ceiling. Some buildings and structures degrade or block radio signals. The outdoor environment is typically open space that may contain natural and man made structures. The outdoor-to-indoor environment is present when a radio signal is transmitted from the outdoor environment 110 to the indoor environment 108. The outdoor-to-indoor environment is typically encountered when the WWAN AN 102 attempts to page a wireless mobile device 104 that is located indoors within a building or other interfering structure.

In practice, these different channel environments occur in some WWAN coverage regions (cells). The presence of these different channel environments in a single coverage region can cause coverage holes. Principally, there are two causes of coverage holes: radio signal attenuation (including blocking) and fading. Within these coverage holes, WWAN paging service is typically not available to the wireless mobile devices 104. In addition, they can also cause dropouts when a wireless mobile device 104 moves from the indoor WLAN coverage area 114, where it is receiving wireless services through the WLAN, to the outdoor environment 110, where there is an inter-technology handoff from the WLAN to the WWAN.

To improve WWAN paging coverage, the WWAN AN 102 selectively varies the effective modulation order of a broadcast paging channel to achieve improved paging coverage within poor coverage regions, e.g., WWAN coverage holes. The WWAN preferably uses various orders of quadrature amplitude modulation (QAM), i.e., M-ary QAM, where M is a power of two. Described herein below are certain methods for varying the modulation order of the paging channel of the WWAN or for using layered modulation to variously modulate different components of the paging channel.

By broadcasting page messages at different modulation orders, the WWAN AN 102 allows the wireless mobile devices receiving WWAN pages, even while they are in indoor environments using the WLAN for data services or other services. This solution is particularly advantageous where the WLAN and WWAN operate in different frequency bands using different operators and/or air interface technologies.

The WWAN is preferably a cellular network such as a cdma2000, WCDMA, GSM, UTMS network or the like. The WWAN includes infrastructure comprising those network elements necessary to support wireless voice and data communications with the wireless mobile devices 104. The wireless communication infrastructure includes equipment such as controllers, transceivers and backhaul that establishes and maintains wireless communication with the wireless mobile devices 104, as well as other terminal devices. The types and amount of equipment within the wireless infrastructures depend on the particular wireless network. For example, a typical cellular network includes sector antennas connected to several base transceiver stations (BTSs) connected to base station controllers (BSCs) that are connected to a Mobile Switching Center (MSC). Cellular base station controllers are typically capable of communicating with an IP-based network, such as Internet, via a packet data server node (PDSN). Base stations are also capable of communicating with the public switched telephone network (PSTN) via the MSC. Thus, conventional cellular base stations included in the WWAN use the MSC and PSTN to provide conventional voice connections and telephony services between the wireless mobile devices 104 and other telephone devices over the WWAN. In addition, base stations of the WWAN use a PDSN and the Internet to provide packet data services, such as voice-over-IP (VoIP) and short messaging service (SMS), between the wireless mobile devices 104 and Internet protocol (IP) nodes communicating with the WWAN.

For seamless mobility of voice communication, VoIP may be provided by both the WLAN and WWAN. In this type of communications system, the AN may replace the BTS, and a PCF (Packet Call Function) could replace the BSCs in the WWAN. The PCF would connect directly to the PDSN.

In certain WWANs, an IP multimedia subsystem (IMS) serves as the core network. The IMS can support both the WWAN and WLAN to provide seamless handoffs between the two technologies. Specifically, the WLAN can be connected to the IMS via an IWF (interworking function), which is controlled by the cellular carrier.

In addition, in WWANs using Unlicensed Mobile Access (UMA) Technology, GSM and GPRS mobile services are available over WiFi. The WiFi network is connected to the cellular core network through the IP access network and a UMA network controller.

The WLAN is preferably a packet-based network, such as a WiFi network (e.g., IEEE-802.11a/b/g/n), that supports a peer-to-peer protocol between those wireless mobile devices 104 that feature multi-mode capabilities. The WLAN includes those network elements necessary to support data and voice communications with the wireless multi-mode devices. For example, the WLAN may support voice-over-IP (VoIP) service over the WiFi connections.

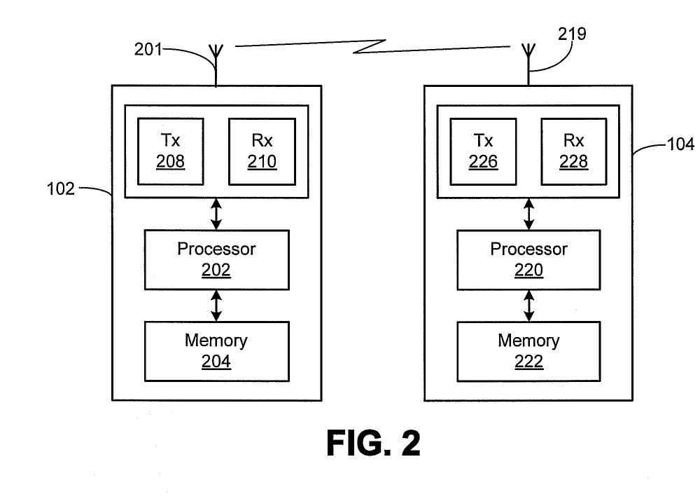

FIG. 2 is a diagram illustrating general details of the WWAN AN 102 and one of the wireless mobile devices 104 included in the communications system 100.

Although the present invention is not limited to any particular implementation of the WWAN AN 102, the WWAN AN 102 is preferably a cellular base station, as described above, that is connected to or includes at least one antenna 201, and includes a processor 202, a memory 204 and an air interface with a radio frequency transceiver 206 having a transmitter (Tx) 208 and a receiver (Rx) 210 for communicating with the wireless mobile devices 104. The processor 202 is configured to perform in accordance with at least one the paging methods described herein, and may perform other baseband processing of digitized information. This processing typically comprises modulation and demodulation, encoding and decoding, interleaving and de-interleaving, multiplexing, error correction operations and the like. As such, the processor 202 is generally implemented in one or more digital signal processors (DSPs) and/or application specific integrated circuits (ASICs). The memory 204 stores one or more software programs executed by the processor 202 to perform its functions.

The AN 102 may be implemented with other architectures. For example, the transceiver 206 and/or antenna(s) 201 may be located outside of the AN 102, with the AN 102 connected thereto.

Each wireless mobile device 104 includes at least one antenna 219, a processor 220, a memory 222 and an air interface with radio frequency transceiver 224 having a transmitter (Tx) 226 and a receiver (Rx) 228 for communicating with the WWAN AN 102. Those wireless mobile devices 104 having multi-mode capabilities also include an additional air interface and transceiver from communicating with the WLAN AP 112. The processor 220 is configured to extract page messages broadcasted by the WWAN AN 102 according to one or more of the methods described herein. The processor 220 may also perform other baseband processing of digitized information. This processing typically comprises modulation and demodulation, encoding and decoding, interleaving and de-interleaving, multiplexing and de-multiplexing, error correction operations and the like. As such, the processor 220 is generally implemented in one or more digital signal processors (DSPs) and/or application specific integrated circuits (ASICs). The memory 222 stores one or more software programs executed by the processor 220 to perform its functions.

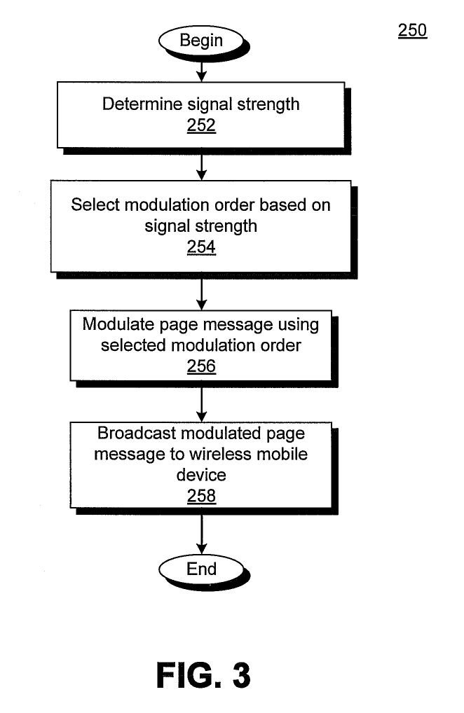

FIG. 3 is a flowchart 250 illustrating a first method of broadcasting a page message in the communications system 100. In step 252, the wireless mobile device 104 being paged monitors the signal strength received from the WWAN AN 102. The signal strength can be derived from the pilot signal transmitted by the AN 102. Alternatively or additionally, the wireless mobile device 104 may monitor the success/failure of messages sent to/from the WWAN AN 102 to determine the signal strength.

In step 254, the AN 102 selects a page channel modulation order based on a request from the wireless mobile device 104. The request can indicate the signal strength detected by the wireless mobile device 104. The wireless mobile device 104 can transmit the request indicating the signal strength to the AN 102 on a reverse control link. The modulation order and other related parameters can be negotiated between the wireless mobile device 104 and the AN 102 as soon as a change in signal strength is detected, such as going from good signal strength to poor signal strength, or visa versa. The request for modulation order can additionally or alternatively be incorporated into any access attempt or access message from the wireless mobile device 104 to the WWAN, including a registration message or L2 response.

Although any suitable modulation order or number of modulation orders may be used, the default modulation order for the paging channel may be set to 16-QAM for users in outdoor environments or otherwise in good coverage regions.

If the detected signal strength is low (e.g., the wireless mobile device 104 is within the indoor environment 108) the wireless mobile device 104 requests to the AN 102 that any page message sent on the paging channel be sent in a lower-order modulation for higher robustness (e.g., QPSK instead of 16-QAM).

The modulation order request sent by the wireless mobile device 104 in step 254 can also be used to adjust the robustness of a quickpaging channel (QPCh). The QPCh carries a single bit indicating the presence of a page. Typically, to make the QPCh robust, it is either repeated multiple times or transmitted at a higher power-level by the AN 104. When the wireless mobile device 104 requests a certain modulation order, it provides an indication for the AN 102 to configure the parameters for the QPCh. In this case, the parameters are either the number of repetitions or/and the power-level to be used for QPCh. If the request is for a lower-order modulation, the QPCh parameters are adjusted by the AN 102 to relatively increase the QPCh transmission repetitions and/or power level; whereas a request for higher-order modulation results in a relative decrease in QPCh transmission repetitions and/or power level.

In step 256, the AN 102 modulates the page message using the selected modulation order. In step 258, the AN 102 broadcasts the modulated page message on the paging channel to the recipient wireless mobile device 104. The wireless mobile device then demodulates the page message using the selected modulation order. Since the page message has the same content regardless of whether it is modulated using QPSK, 16-QAM, the paging slot would be twice as long for QPSK when compared to 16-QAM. Therefore, wireless mobile devices 104 requesting QPSK modulation or other lower-order modulations would need to turn on their receivers 228 for longer durations to monitor pages in their slot cycle than wireless mobile devices 104 operating in good channel environment using 16-QAM.

If the page is received successfully, the traffic channel can also use the selected modulation order to transmit the contents of the voice or data packets to the wireless mobile device 104 in a poor coverage region.

For some wireless mobile devices operating in poor coverage, it is possible that the page messages may not be received successfully, even though such wireless mobile devices can successfully send control messages, such as page acknowledgements (ACKs), on the reverse link. This is because the gain on the paging channel broadcasted by the AN is typically fixed regardless of the location of the wireless mobile device. However, for control messages on the reverse link, e.g., page ACKs, the wireless mobile device has the option to boost up its transmission signal strength to compensate for poor coverage (up to Pmax).

In other poor coverage situations, it is possible that some wireless mobile devices may not be able to send page ACKs back to the AN, even it if they did receive page messages successfully. In the case when a wireless mobile device receives a page successfully or when the wireless mobile device receives only the page message using the lower modulation order, but cannot ACK the page due to reverse link limitations, the wireless mobile device can indicate to the user that a page has been received (including the calling party number), but that the call completion was unsuccessful. This user indication is applicable in all of the paging methods described herein.

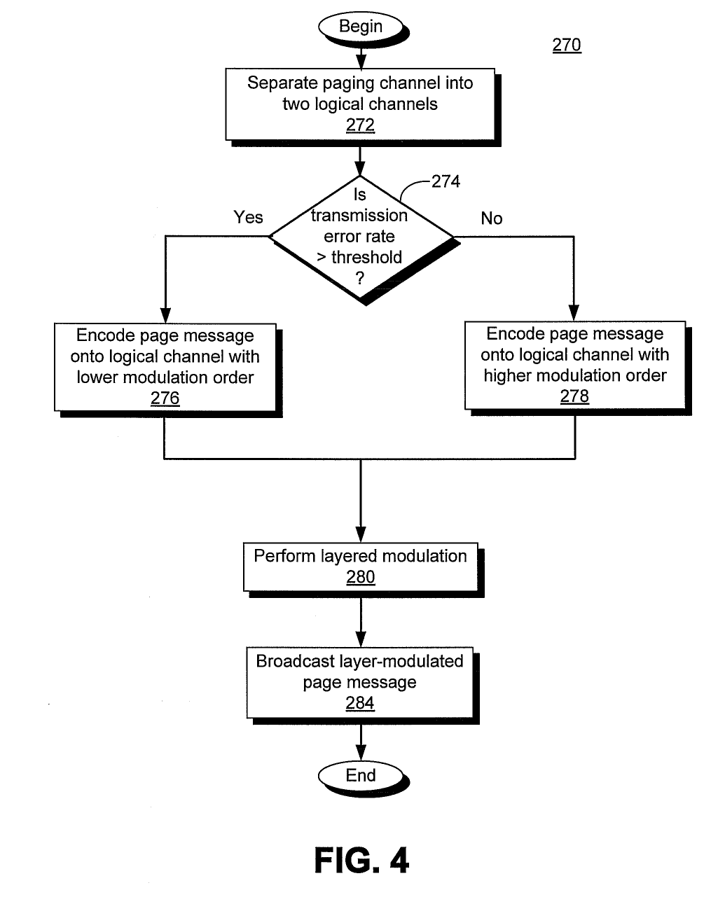

FIG. 4 is a flowchart 270 illustrating a second method of broadcasting a page message in the communications system 100. The second method uses layered modulation to provide paging service to both the indoor and outdoor environments 108, 110, or wherever coverage holes exist. Under this method, the paging channel is divided into two logical channels: a base channel, which uses a lower-order QAM modulation to improve robustness for poor coverage regions; and an extended channel, which uses a higher-order QAM modulation for good coverage regions.

The method of FIG. 4 has the benefit of concurrently sending two independent pages to two wireless mobile devices 104 experiencing different channel environments. With this method, two groups of wireless mobile devices 104 are created. One group listens to the base logical channel of the paging channel and the other group listens to the extended logical channel of the paging channel, depending upon their respective channel environments. The paging channel is a dedicated control channel. However, paging is broadcasted like other control channels, and thus, only paged wireless mobile devices 104 stay up to listen the entire page message. With this method, two wireless mobile devices 104 may stay up to listen to their respective page messages: one on the base channel and the other extended channel.

In step 272, the AN 102 divides the paging channel itself into the base channel and the extended channel. An entire page message is transmitted by the AN 102 on either the base paging channel or the extended paging channel, depending on the logical channel selected for the recipient wireless mobile device 104. Each of these channels is independently encoded and interleaved by the AN 102. Any other pre-modulation processing on the base and extended channels is also performed independently.

The AN 102 determines the appropriate page messages to be grouped together to form the base and extended message pairs for the layered modulation. If pages are needed for only one type of channel environment, i.e., the wireless mobile devices 104 request only the base channel or extended channel, but not both, the non-requested paging channel can carry other data or fill data. If only the base channel has paging data to be sent and there is only fill data on the extended channel, the modulation symbols in the QAM constellation representing the base channel data may be selected to achieve the greatest distance, on average, from the symbols in the other quadrants.

Initially, the AN 102 may assign a wireless mobile device 104 to a default logical paging channel, either the base channel or the extended channel, unless otherwise negotiated. The default paging channel does not have to be the same for all of the wireless mobile devices 104. The default paging channel may be negotiated during registration of the wireless mobile device 104 on the WWAN, for example. The request for a particular logical paging channel can be incorporated into any access attempt or access message from the wireless mobile device 104 to the AN 102, including a registration message or L2 response.

A wireless mobile device 104 may switch from extended to base channel, and visa versa, whenever warranted by channel conditions. There are several ways of determining when to switch between base and extended paging channels. As shown in decision step 274, a wireless mobile device 104 can maintain common channel error rates for other channels, such as a broadcast message control channel or the base and extended components of overhead message control channels, as described in the Related U.S. patent application No. ______, filed ______, entitled “System and Method for Broadcasting Overhead Parameters in Poor Coverage Regions”, Attorney Docket No. TUTL 00136. Depending on the common channel error rates, the wireless mobile device 104 may assign crossover points as trigger points to request the WWAN AN 102 to send page messages over either the base or the extended channel. For example, if the common channel error rate exceeds a threshold (e.g., a trigger point), the AN 102 encodes, interleaves and processes the outgoing page message onto the base logical channel, which uses a lower-order QAM modulation to improve robustness (step 276). If, on the other hand, the common channel error rate is less than the threshold, the AN 102 encodes, interleaving and processes the outgoing page message onto the extended logical channel, which uses a higher-order QAM modulation for reception in good coverage areas (step 278).

Alternatively, the wireless mobile device 104 can detect when it first acquires or loses WLAN service and then switch paging channels at that time. When a wireless mobile device 104 first acquires a WLAN, this situation usually indicates that the wireless mobile device 104 is about to move from a good coverage area into a coverage hole. Typically, when the WLAN is first acquired (e.g., at the entry of a building), WWAN services are still available; and therefore, at this particular time, requests to the WWAN AN 102 can still be completed successfully. It is at this particular time that a wireless mobile device 104 can send a request to the AN 102 to switch from the extended paging channel to the base paging channel. Conversely, when the wireless mobile device 104 first detects loss of the WLAN, it can request the AN 102 to switch back to the extended paging channel.

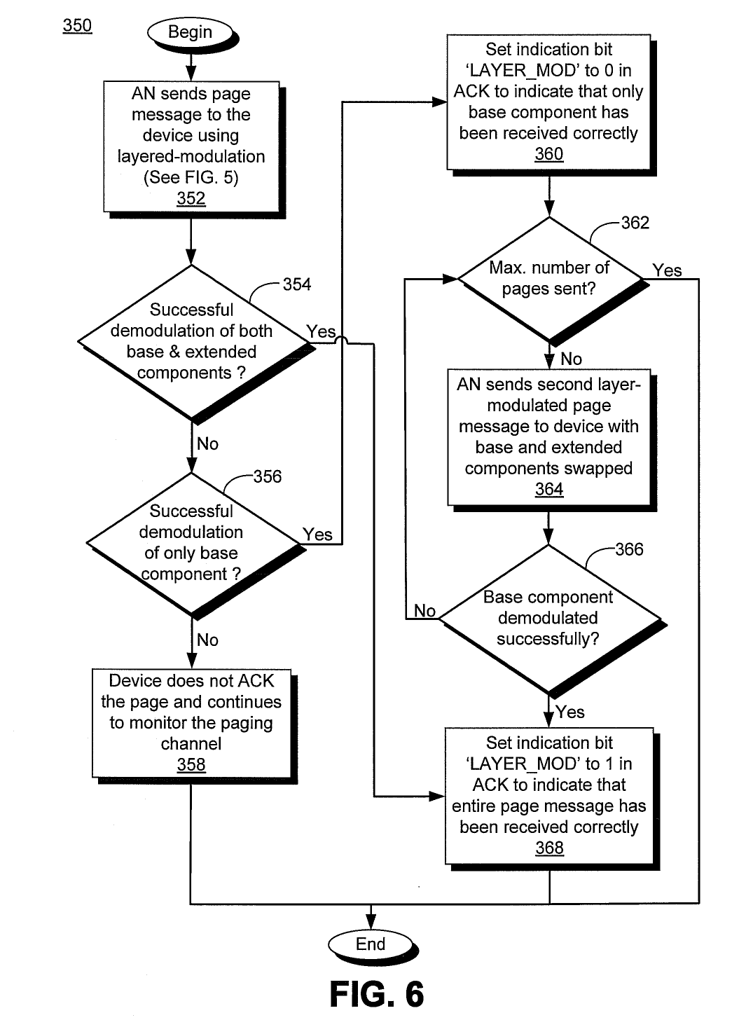

In step 280, the base and extended channels are multiplexed together and layer modulated using layered QAM, as described in further detail herein in connection with FIGS. 7-11.

In step 284, the layer-modulated page message is broadcast by the AN 102 to the recipient wireless mobile device 104.

The request sent by the wireless mobile device 104 to switch between the base and extended paging channels can also be used to adjust the robustness of a quickpaging channel (QPCh). The QPCh carries a single bit indicating the presence of a page. Typically, to make the QPCh robust, it is either repeated multiple times or transmitted at a higher power-level by the AN 104. When the wireless mobile device 104 requests a certain logical paging channel, it provides an indication for the AN 102 to configure the parameters for the QPCh. In this case, the parameters are either the number of repetitions or/and the power-level to be used for QPCh. If the request is for the base channel, the QPCh parameters are adjusted by the AN 102 to relatively increase the QPCh transmission repetitions and/or power level; whereas a request for the extended channel results in a relative decrease in QPCh transmission repetitions and/or power level.

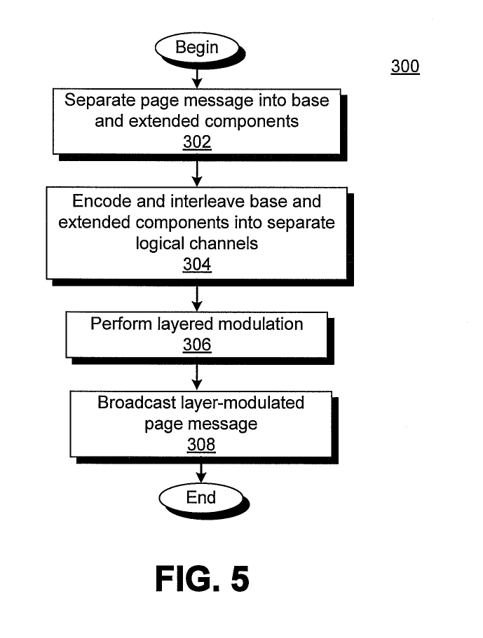

FIGS. 5-6 are flowcharts 300, 350 illustrating a third method of broadcasting page messages in the communications system of 100. The third method also uses layered modulation. However, in contrast to the second method described in connection with FIG. 4, the third method processes and layer-modulates only a single page message at a time. The single page message is divided into two components: a base component and an extended component. The base and extended components are then transmitted on base and extended logical paging channels, respectively, which are layer modulated. The page message may be addressed to a wireless mobile device 104 in either indoor or outdoor environments 108, 110.

FIG. 5 is a flowchart 300 illustrating the steps taken by the WWAN AN 102 to broadcast a page message to a recipient wireless mobile device 104 in accordance with the third method. With this method, the page message is divided into base and extended components that are encoded onto separate logical channels and layer modulated. Using layered modulation, the wireless mobile devices 104 can receive base components in poor coverage regions. In poor coverage regions, the recipient wireless mobile device 104 receives successive base component transmissions to receive a complete page message. In good coverage regions, the recipient wireless mobile device 104 simply demodulates both base and extended components to recover the entire page message from a single transmission.

In step 302, the AN 102 divides a page message into base and extended components. The page message can be divided into the components in equal proportions, or any other suitable proportion. The base component may include at least the minimum information required by the recipient wireless mobile device 104 to complete the page process.

In step 304, the AN 102 constructs the base and extended components into two separate logical channels: the base channel and the extended channel. Each of these channels is independently encoded and interleaved by the AN 102. Any other pre-modulation processing on the base and extended components is also performed independently.

In step 306, the AN 102 multiplexes and then modulates the two logical channels using layered modulation. Layered quadrature amplitude modulation (QAM) is preferably used. Layered modulation supports the division of page messages into two logical channels. Using layered modulation allows the wireless mobile devices 104 to demodulate the base component under poor channel conditions. Layered modulation also allows the use of the same physical packet format (i.e., the same packet length, cyclic-preamble for OFDM, and so forth) to serve multiple wireless mobile devices 104 in different channel environments. Thus, wireless mobile devices 104 in good coverage conditions (e.g., the outdoor environment 110) can demodulate both the base and the extended components with relatively ease. Further details of the layered modulation performed by step 306 are described below in connection with FIGS. 7-9.

Typically in the outdoor-to-indoor environment, the wireless mobile device 104 is able to receive enough energy from the WWAN AN 102 to detect a pilot channel used for synchronization and channel estimation. However, the wireless mobile device 104 may not receive sufficient signal energy to fully demodulate the WWAN paging channel. Splitting the paging channel into the base and extended components and applying layered modulation to these components allows the wireless mobile device 104 to demodulate the critical base component at a much lower received signal level.

In step 308, both base and extended components are broadcasted on the paging channel by the WWAN AN 102 to the wireless mobile devices 104.

The method of FIG. 5 is especially useful in the outdoor-to-indoor environment where the recipient wireless mobile device 104 experiences relatively high signal loss due to the loss from building penetration. However, in general, this method is useful in any environment where the channel condition is poor.

FIG. 6 is a flowchart 350 illustrating the steps taken by the recipient wireless mobile device 104 and AN 102 to send a page message in accordance with the third method. In step 352, the AN sends the page message to the recipient wireless mobile device 104, as described in connection with FIG. 5.

In step 354, the wireless mobile device 104 determines whether the signal strength is strong enough so that it can successfully demodulate both the base component and extended component channels. If the device 104 is capable of successfully demodulating both page component channels, it proceeds to extract the entire page message from the page channel. The device then sends a page acknowledgement (ACK) to the AN 102 with an indication bit LAYER_MOD set to ‘1’ to indicate that the entire page message was correctly received.

However, if the device cannot demodulate both the base and extended components, the wireless mobile device 104 determines whether it can successfully demodulate only the base component channel (step 356).

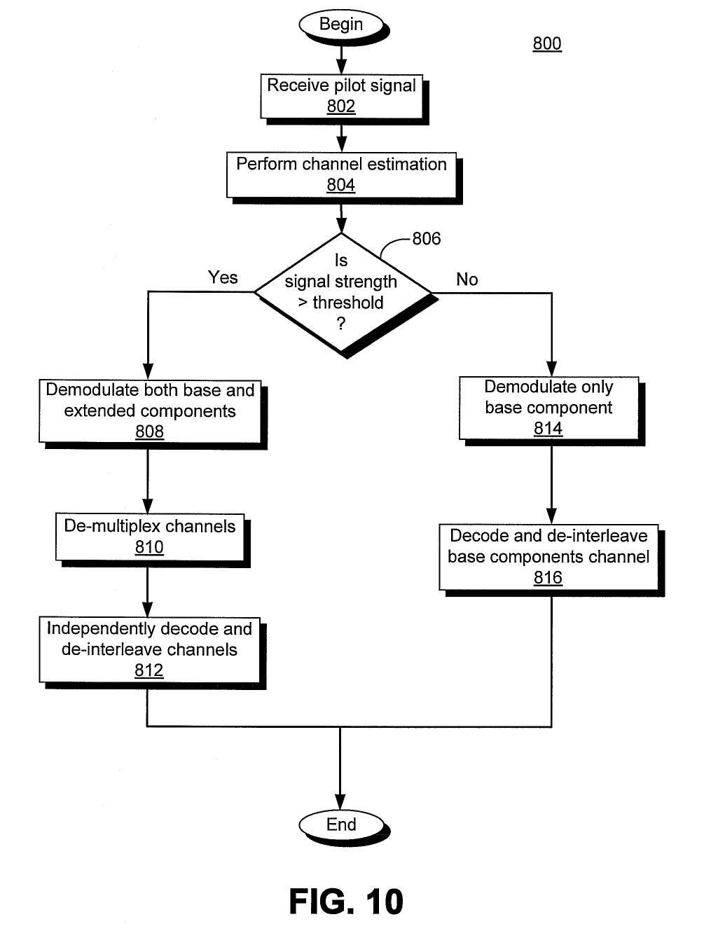

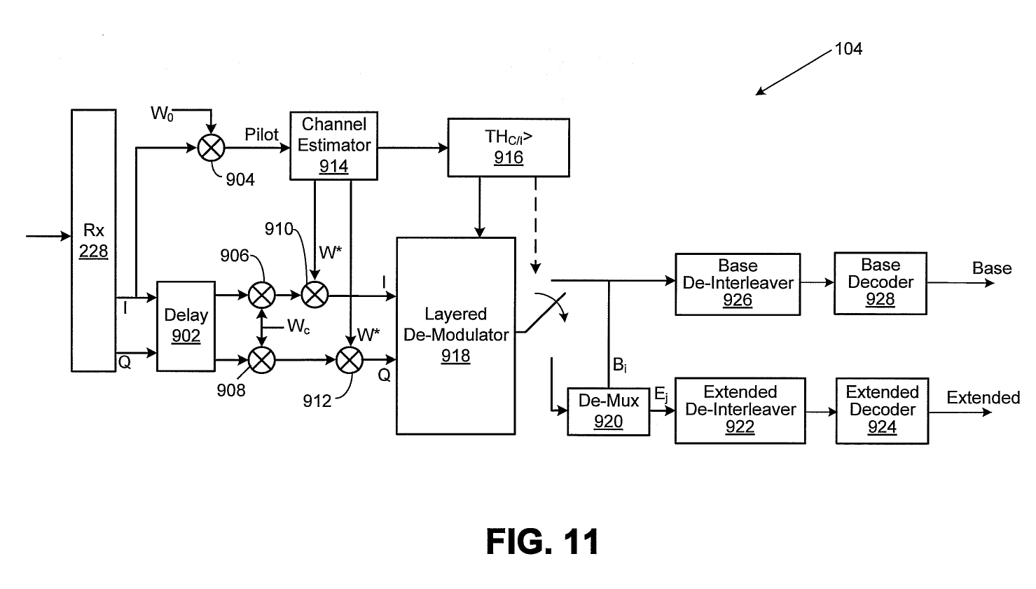

Further details of decision steps 354 and 356 are described below in connection with FIGS. 10-11.

If the received signal strength is too weak to permit the wireless mobile device 104 to demodulate even the paging channel's base component, the device 104 does not send a page ACK to the AN 102, and continues to monitor the paging channel for subsequent pages.

If the signal strength is strong enough to permit demodulation of only the base component, but not the extended component, the wireless mobile device 104 proceeds to demodulate and extract the base component of the page message. In step 360, the device 104 then sends a page ACK to the AN 102 with the indication bit LAYER_MOD set to ‘0’ to indicate that only the base component of the page message was correctly received.

In step 362, the AN 102 determines whether the maximum number of pages has been sent to the recipient wireless mobile device 104. If so, the AN 102 discontinues paging the device 104 for the current page message. If not, the AN 102 processes the extended component of the page message onto the base component channel and sends a second page message to the device 104 with the base component essentially swapped with the extended component (step 364). To prevent possible confusion, the page message may include an indication bit to inform the wireless mobile device 104 that the current page message content has been swapped.

In step 366, the wireless mobile device 104 determines whether it has successfully demodulated the base component of the second page message. If not, the process returns to step 362, and the AN 102 may attempt to re-send the second page message, if the maximum number of pages has not been exceeded. If demodulation of the second page message is successful, the device 104 sends a page ACK to the AN 102 with the indication bit LAYER_MOD set to ‘1’ to indicate that the entire page message was correctly received (step 368).

Using the third paging method, a recipient wireless mobile device 104 in good coverage conditions can successfully demodulate the extended and base components (16-QAM modulated paging channel) with no error. If the device 104 is in poor coverage conditions and only the base component can be demodulated successfully, the wireless mobile device 104 saves the base component page message content and sends an indication in the form of an ACK to the WWAN AN 102 that only the base component is successfully demodulated. After the AN 102 receives the ACK with the indication, the AN 102 re-transmits the page message to the device 104 with the exception that the portion of the page message previously sent on the extended component is now sent over the base component. The device 104 receives the second page and is able to demodulate the base component comprising page message information not successfully demodulated in the first page attempt.

The third paging method has several advantages. The first advantage is that only wireless mobile devices 104 experiencing poor channel environments need to monitor successive page messages. In addition, the wireless mobile devices 104 in good coverage areas do not need to wake up for a longer duration to listen to page messages just to support wireless mobile devices 104 in poor coverage areas. Furthermore, the third method does not require that the recipient wireless mobile device 104 inform the AN 102 whether the page message should be sent on the base or the extended component. Additionally, since only one page message is sent in the paging slot using layered modulation that is formed by the base and extended components, a wireless mobile device 104 in good coverage conditions would need to wake up for only half the time to monitor paging messages as compared to the second method described above in connection with FIG. 4.

For all of the above methods, the recipient wireless mobile device 104 may send a page ACK to the AN 102 in one of several ways. First, the page ACKs can be transmitted using the WWAN traffic uplink. Typically, reverse-link control channels have a more robust air-link than the reverse-link traffic channel. This is done to provide reliable feedback to the AN 102 so that the AN 104 can adapt to provide efficient performance. With more robust encoding and modulation, ACKs transported on the reverse-link channels are more reliable.

Second, the page ACKs can be transmitted through the WLAN, if the wireless mobile device 104 is in a WLAN coverage area 114. To send page ACKs through the WLAN, the WLAN is connected to the WWAN's IP multimedia subsystem (IMS). This could also be an indication that the user prefers to have that particular service on WLAN if paged.

FIG. 7 is a diagram illustrating components of the AN 102 for broadcasting layer-modulated page information. The AN 102 includes a base component encoder 500 and interleaver 502, an extended component encoder 504 and interleaver 506, a multiplexer (Mux) 508, a layered modulator 510, Walsh Codes (W₀, W_{C}) multipliers 512, 512, 518, gain multipliers 516, 520, time division multiplexer (TDM) 522 and the transmitter 208. The elements 500-522 of FIG. 7 can be implemented in the AN processor 202.

The encoders 500, 504 and interleavers 502, 506 provide error correction processing. The encoders 500, 504 may employ any suitable error correction coding, such as turbo coding, and the interleavers 502, 506 may employ any suitable interleaving algorithm.

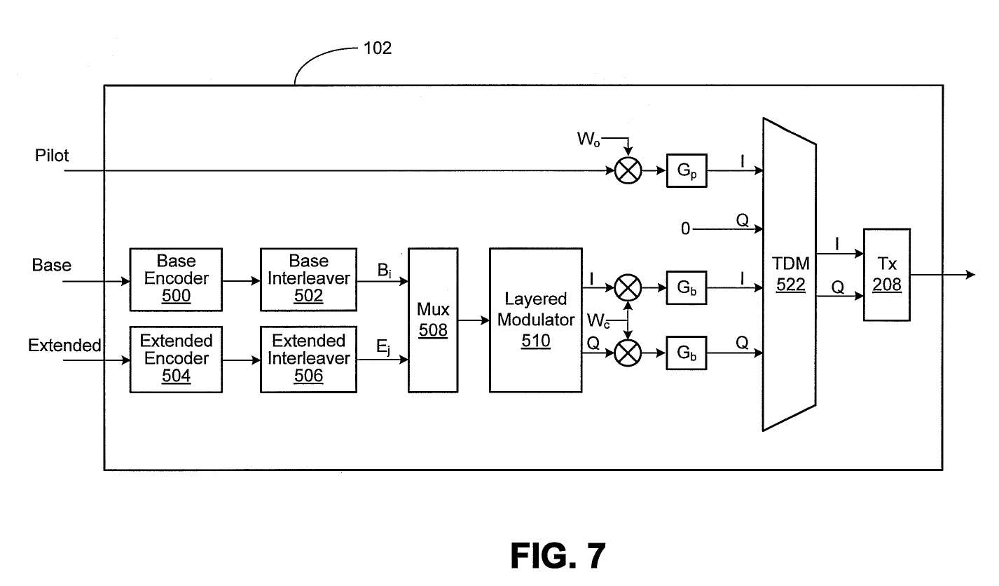

FIGS. 7-9 essentially describe how the base and extended logical channels are mapped into the layered modulation symbols. As depicted in FIG. 7, each of the base and extended components are individually encoded and interleaved. The outputs of the logical channels Bᵢ, Eⱼ are multiplexed by Mux 508, as depicted in FIG. 8. Depending on the amount of information that make up the base component, the multiplexing may be varied. For example, instead of alternating the bits from each of the components for multiplexing, each base logical bit may be followed by three extended logical bits.

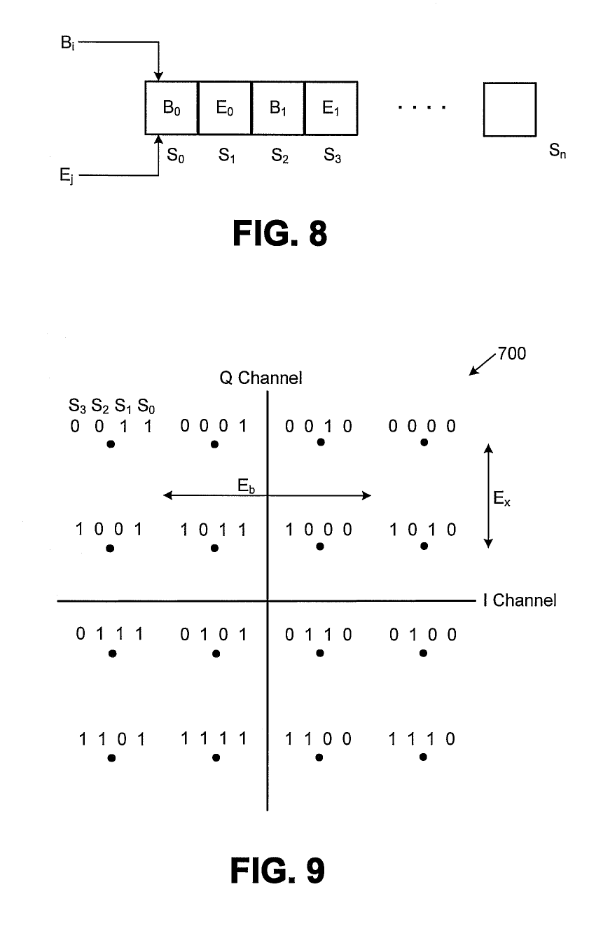

FIG. 9 shows an exemplary 16-QAM constellation 700 illustrating the layered modulation symbols produced by the layered modulator 510. In this example, each modulation symbol represents four multiplexed bits (i.e., S3, S2, S1, S0). The multiplexed bits from the base component are represented by S0 and S2, while the multiplexed bits from the extended component are represented by S1 and S3. The modulation symbols are constructed such that S0 and S2 do not change within the same quadrant. Therefore, the multiplexed bits from the base component are essentially QPSK modulated while the multiplexed bits from the extended component are 16-QAM modulated.

As shown in FIG. 7, the base and extended components are modulated and then transmitted along with a pilot signal. The pilot gain (Gₚ) is independent from the gain (G_{b}) for the base and extended components.

To additionally improve reception of the base components, the AN 102 can also adjust the energy level of the 16-QAM modulation symbols, as shown in FIG. 10, to favor the base component. This is done by increasing the distance between the centers of each quadrant (E_{b}) relative to the distance between the modulation symbols within a quadrant (Eₓ).

FIG. 10 is a flowchart 800 illustrating a method of recovering page messages at one of wireless mobile devices 104. In step 802, the wireless mobile device 104 received a pilot signal from the AN 102. In step 804, the wireless mobile device performs a channel estimation by determining the strength of the pilot signal using a conventional network parameter, such as the carrier-to-interference ratio (C/I). In decision step 806, the pilot signal strength is compared to a threshold (TH_{C/I}). If the pilot signal strength is above TH_{C/I}, then the wireless mobile device 104 proceeds to de-modulate, de-multiplex, decode and de-interleave both the base and extended components (steps 808-812). If not, the wireless mobile device 104 de-modulates, decodes and de-interleaves only the base component (steps 814-816).

Alternatively, the wireless mobile device 104 may monitor broadcasted signal strength and attempt to recover a page message without a threshold comparison. In this case, the wireless mobile device 104 demodulates both the base and extended components at all times. The base and extended components may indicate successful recovery of the page message depending on the outcome of error checking, e.g., the CRC (cyclic redundancy check) or equivalent, for each of the components.

FIG. 11 is a diagram illustrating components of the wireless mobile device 104 for recovering broadcasted, layer-modulated information. The components shown in FIG. 11 allow the wireless mobile device 104 to receive at least part of a page message by demodulating the base component. The wireless mobile device 104 includes the receiver 228, a delay buffer 902, Walsh-Codes (W₀, W_{C}), and coefficient (w*) multipliers 904, 906, 908, 910, 912, channel estimator 914, threshold comparator 916, layered demodulator 918, de-multiplexer 920, base component de-interleaver 926 and decoder 928, and extended component de-interleaver 922 and decoder 924. The elements 902-928 shown in FIG. 11 can be implemented in the wireless mobile device processor 220.

The channel estimator 914 provides a signal strength, C/I, to the threshold comparator 916, which determines the QAM modulation order to be used by the layered demodulator 918. The threshold comparator 916 can include one or more look-up tables (LUTs) to store signal-to-noise ratio (SNR) ranges and corresponding modulation order values and/or code-rate. The LUTs for the SNR may be updated depending on the relative levels of the pilot gain (Gₚ) and the gain used in the base logical component, since the pilot level transmitted may change depending on traffic conditions. If the threshold comparator 916 indicates that SNR is sufficient, both base and extended components can be demodulated successfully using the 16-QAM demodulator.

However, if the threshold comparator 916 indicates a low SNR, it is possible that only the base component can be successfully demodulated. In this case, for each received 16-QAM symbol, the layered demodulator 918 only needs to determine in which quadrant the symbol has the least probability of error. Instead of choosing among the sixteen possible 16-QAM symbols, the layered demodulator 918 only needs to make a decision based on four possible outcomes (similar to QPSK demodulation). This is possible because the modulation symbol for each quadrant does not change with respect to the base component bits.

Although a particular communication system 100 is specifically described above, the methods and systems described herein are applicable to any suitable communications system architecture or air interface technology (e.g., CDMA, OFDMA, and the like). Basic radio system parameters and call processing procedures for exemplary CDMA WWAN systems that can incorporate the systems and methods described herein are described in a TIA specification, entitled “Mobile Station-Base Station Compatibility Standard for Dual-Mode Wideband Spread Spectrum Cellular System,” TIA/EIA/IS-95-A, published in May 1995 by the Telecommunications Industry Association, and referred to hereafter as “IS-95A”. The update and revision to IS-95A and J-STD-008 (PCS specification analogous to IS-95A) is TIA/EIA/IS-95-B, first published in March 1999 by the TIA and referred to hereafter as “IS-95B”. The IS-95A and IS-95B specifications are jointly known as second generation or “2G” CDMA system specifications. A third generation or “3G” CDMA system is described in the TIA specification, entitled “cdma2000 Series”, TIA/EIA/IS-2000-A, first published in March 2000 by the TIA, and referred to hereafter as “IS-2000”. Other TIA air interface specifications for the cdma2000 family of standards include TIA-856 entitled “cdma2000 High Rate Packet Data Air Interface Specification” as well as TIA-1121 entitled “Ultra Mobile Broadband Air Interface Specification. The IS-95A, IS-95B, IS-2000 and other TIA specifications mentioned above, and their updates are hereby incorporated by reference for their teachings on CDMA communication systems.

Other embodiments and modifications of this invention will occur readily to those of ordinary skill in the art in view of these teachings. The above summary and description is illustrative and not restrictive. The invention is to be limited only by the following claims, which include all such embodiments and modifications when viewed in conjunction with the above specification and accompanying drawings. The scope of the invention should, therefore, not be limited to the above summary and description, but should instead be determined by the appended claims along with their full scope of equivalents.

What is claimed is:

1. A wireless communications system, comprising:
a wireless mobile device for requesting a paging channel modulation order; and
an access node comprising:
a modulator for modulating a page message using the paging channel modulation order to produce a modulated page message, and
a transmitter for broadcasting the modulated page message to the wireless mobile device.

2. The communications system of claim 1, wherein the modulation order is an M-ary QAM, where M is a power of two.

3. The communications system of claim 1, wherein the selected modulation order increases with an increase in a received signal strength at the wireless mobile device.

4. The communication system of claim 1, wherein the access node further comprises means for adjusting one or more quick page channel parameters based on a paging channel modulation order request from the wireless mobile device.

5. The communications system of claim 1, wherein the wireless mobile device transmits a request for paging channel modulation order in an access request to the access node.

6. A wireless communications system, comprising:
an access node for broadcasting layer-modulated first and second logical paging channels, the first logical paging channel for transmitting a first page message and the second logical paging channel for transmitting a second page message;
a first wireless mobile device configured to demodulate the first logical paging channel to receive the first page message; and
a second wireless mobile device configured to demodulate the second logical paging channel to receive the second page message.

7. The wireless communications system of claim 6, wherein the first and second wireless mobile devices request the first logical paging channel and the second logical paging channel, respectively, upon making respective access requests.

8. The wireless communications system of claim 6, wherein the first and second wireless devices each include means for selectively switching between the first logical paging channel and the second logical paging channel.

9. The wireless communications system of claim 8, wherein the first and second wireless devices each switch between the first logical paging channel and the second logical paging channel based on a common channel error rate.

10. An access node for use in a wireless communications system, comprising:
a processor for separating a page message into a first message component and a second message component;
a first encoder for encoding the first message component onto a first logical paging channel;
a second encoder for encoding the second message component onto a second logical paging channel;
a modulator for layer modulating the first and second logical paging channels to produce a layer-modulated signal; and
a transmitter for broadcasting the layer-modulated signal to a wireless mobile device.

11. The access node of claim 10, wherein the modulator modulates the first logical channel with an M-ary QAM, where M is a power of two and the modulator modulates the second logical channel with an N-ary QAM, where N is a power of two greater than M.

12. The access node of claim 10, further comprising:
a receiver for receiving an acknowledgement from the wireless mobile device indicating successful demodulation of only the first message component;
wherein in response to receiving the acknowledgement, the first encoder encodes the second message component onto the first logical channel; the modulator re-modulates the first and second logical channel to produce the layer modulated signal; and the transmitter re-broadcasts the layer-modulated signal to the wireless mobile device.

13. The access node of claim 10, further comprising:
a first interleaver for interleaving the first message component on the first logical channel; and
a second interleaver for interleaving the second message component onto the second logical channel.

14. The access node of claim 10, further comprising:
a multiplexer for multiplexing the first and second logical channels.

15. A method of broadcasting a page message to a wireless mobile device, comprising:
separating a paging channel into a plurality of logical channels;
selecting one of the logical channels based on a control channel error rate detected for a separate broadcast channel;
encoding the page message onto the selected logical channel;
layer modulating the selected logical channel and the remaining logical channels to produce a layer-modulated signal; and
broadcasting the layer-modulated signal to the wireless mobile device.

16. The method of claim 15, further comprising:
determining the control channel error rate at the wireless mobile device.

17. The method of claim 15, further comprising:
assigning a predetermined modulation order to each of the logical channels, wherein the predetermined modulation order of the selected logical channel is inversely related to the control channel error rate.

18. A method of broadcasting a page message to a wireless mobile device, comprising:
separating the page message into a first message component and a second message component;
encoding the first message component onto a first logical channel;
encoding the second message component onto a second logical channel;
layer modulating the first and second logical channels to produce a layer-modulated signal;
broadcasting the layer-modulated signal to the wireless mobile device.

19. The method of claim 18, further comprising:
receiving an acknowledgement from the wireless mobile device indicating successful demodulation of only the first message component; and
in response to acknowledgement:
encoding the second message component onto the first logical channel,
re-modulating the first and second logical channel to produce the layer modulated signal, and
re-broadcasting the layer-modulated signal to the wireless mobile device.

20. The method of claim 18, wherein the step of layer modulating includes:
modulating the second logical channel at a higher order modulation than the first logical channel.

21. The method of claim 20, further comprising:
producing a user indication of the page message at the wireless mobile device upon receiving the first message component.

22. The method of claim 18, further comprising:
receiving an acknowledgement from the wireless mobile device indicating successful demodulation of both the first and second message components.
